(19) United States
(12) Patent Application Publication
(10) Pub. No.: US 2012/0114448 A1
(43) Pub. Date: May 10, 2012

(54) FASTENING METHOD OF A FASTENER

(76) Inventor: JHIH-SING LIU, Kahsiung City (TW)

(21) Appl. No.: 12/943,761

(22) Filed: Nov. 10, 2010

(51) Int. Cl. F16B 25/00

(52) U.S. Cl. 411/386

(57) ABSTRACT

A fastening method of a fastener, applied to combine a metal object with a target object, prepares a holder, a cover, and a screw penetrating through the holder in a preparing step, drills a pre-drilled hole on the metal object to receive the holder and to secure the screw in a prearranging step, fixes the screw cased with the holder to the target object in a securing step, and finally places the cover on the holder for enveloping a head of the screw in a lodging step. Accordingly, the screw cased with the holder prevents a shank of the screw from having a direct contact with the metal object. Thus, the screw is not subject to rustiness.

### BACKGROUND OF THE INVENTION

1. Field of the Invention

The present invention relates to a design of a fastener, particularly to a fastening method of a fastener.

2. Description of the Related Art

The common screw secured on objects is in fact easily exposed to the sunlight or to the exterior. In view of the exposed part of the screw, the screw might be gradually deformed or deteriorated in view of the exposure to the sun and oxygen. Herein, the deformed or deteriorated screw might accidentally chafe the skin on people. Moreover, when a metal object is to be fastened to a target object, a physical change will be brought about between the metal object and the screw because they belong to two different metal materials and the contact of the metal materials might result in an adverse influence. Such physical change easily rusts the screw. Therefore, there are producers disclosing an improved design as follows:

Referring to FIG. 1, a conventional protected system 1 comprises a protecting member 11 for a screw 2 to penetrate therethrough and a cover 12 placed on the protecting member 11. Wherein, the protecting member 11 includes a holder 111 formed with an accommodating room 112 therein and an opening 113 defined on a center of the holder 111. By penetrating the accommodating room 112 and the opening 113, the screw 2 is able to be placed on the holder 111. Sheltered by the cover 12, a head 21 of the screw 2 is covered without exposing to the exterior. Referring to FIG. 2, in operation, the screw 2 travels through the holder 111, and a metal object 31 is able to be combined to a target object 3 (e.g. a wall or a non-metal object). Afterward, placing the cover 12 on the head 21 of the screw 2 contributes to an enveloped head 21, and the protected system 1 would be propped against a surface of the metal object 31 for finishing the drilling work.

In the practical application, the head 21 is sheltered by the protected fastener 1, so the chance that the exposed screw chafes the skin on people is reduced, and the head 21 does not easily become rusty since it is simply separated from the metal object 31. However, the means for wrapping the head 21 in the protected fastener 1 is in fact so simple that the liquid or the mist easily gets in the screw 2 through the convergence of the protecting member 11 and the cover 12. As a result, the physical structure of the screw 2 will be damaged. Moreover, in the practical installation, the cover 12 likely falls off the protecting member 11 in view of any careless poke. Thereby, such exposed screw 2 probably incurs aforementioned disadvantages because the fallen protected system 1 does not provide the protection anymore.

Further, it should be also noted that the shank 22 of the secured screw 2 still contacts the metal object 31 directly. Thus, the physical changes, namely the potential difference, plainly exist between the shank 22 and the metal object 31. Herein, the shank 22 is subject to rustiness in view of the potential difference. As a result, the physical structure of the screw 2 is thence influenced, and the fastening effect as well as the using safety is also affected.

### SUMMARY OF THE INVENTION

It is therefore the purpose of this invention to provide a fastening method of a fastener capable of separating a secured screw from a metal object by a holder of the fastener so as to avoid a direct contact of the screw with the metal object and prevent the screw from rusting.

The fastener in accordance with the present invention mainly comprises a preparing step, a prearranging step, a securing step, and a lodging step. Wherein, in the preparing step, a holder, a screw penetrating the holder, and a cover enveloping the holder are prepared. The holder has a body formed with an accommodating room therein, and a tube extended outward from the body. A through hole defined in the tube is communicated with the accommodating room. In the prearranging step, the screw penetrates its correspondent holder by sequentially traveling through the accommodating room and the through hole to engage with the holder. A pre-drilled hole is pre-drilled on the metal object. A receiving area is formed along the pre-drilled hole for accommodating the tube. In the securing step, the screw sleeved with the holder is brought into the pre-drilled hole of the metal object and thence fixed to the target object. Fixing the screw allows the tube to be pushed by the screw for propping against the receiving area, thereby separating a shank of the screw from the metal object via the holder. Finally, in the lodging step, the cover is placed on the body of the holder for sheltering a head of the screw.

Preferably, a top periphery of the body is radially surrounded with a fixing part, and a combining part corresponding to the fixing part is disposed on the cover, so that the combining part is capable of compactly interlocking with the fixing part.

### BRIEF DESCRIPTION OF THE DRAWINGS

FIG. 1 is a schematic view showing a conventional protected fastener;

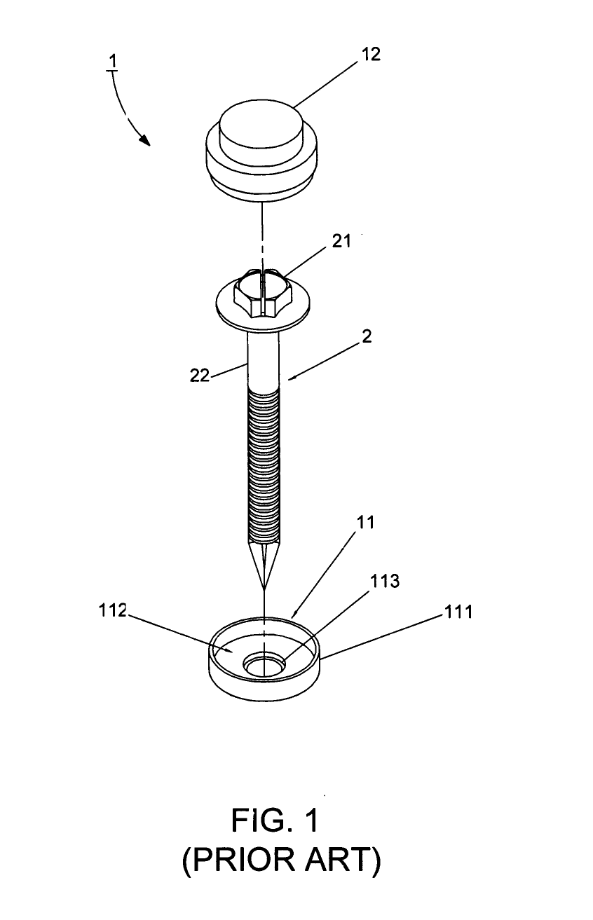

FIG. 2 is a schematic view showing the conventional protected fastener being secured;

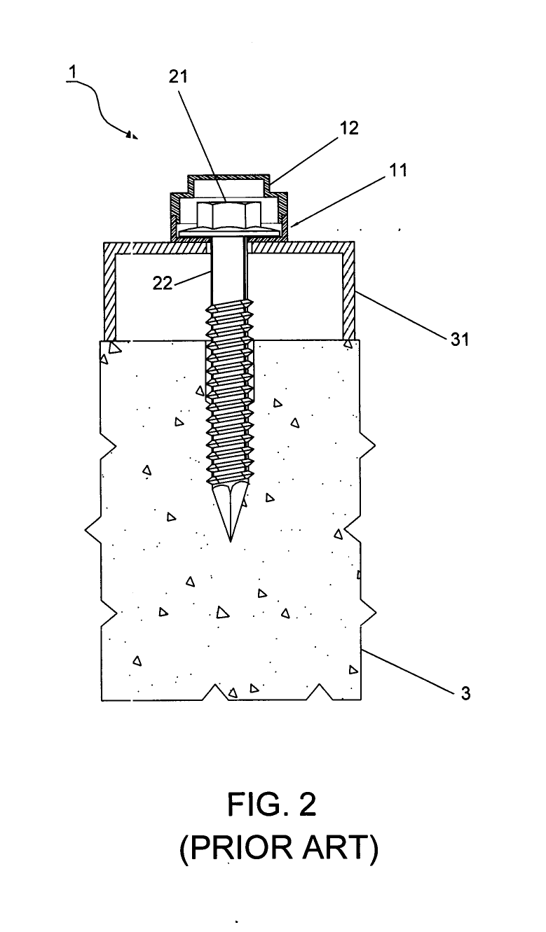

FIG. 3 is a flowchart showing a preferred embodiment of the present invention;

FIG. 4 is a schematic view showing the preferred embodiment of the present invention;

FIG. 5 is a schematic view of the present invention in screwing; and

FIG. 6 is another schematic view of the present invention in screwing.

### DETAILED DESCRIPTION OF THE PREFERRED EMBODIMENTS

Wherever possible, the same reference numbers are used in the drawings and the description to refer to the same or like parts.

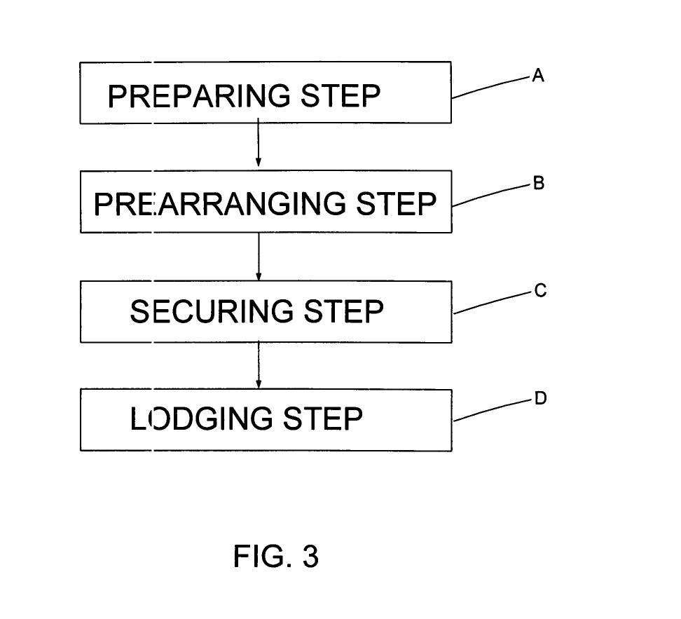

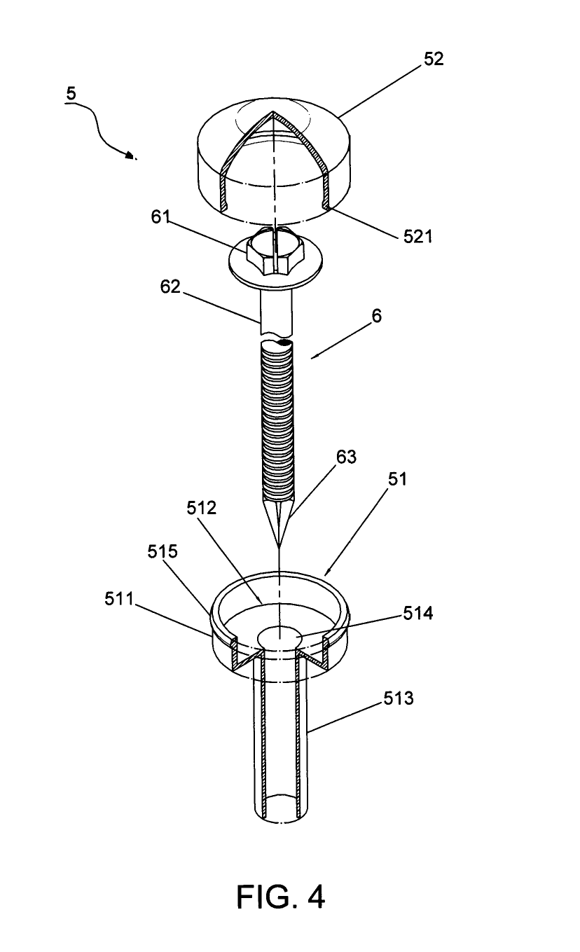

Referring to FIGS. 3 and 4, a preferred embodiment of a fastening method of a fastener is shown. Wherein, the method in accordance with the present invention comprises steps of: a preparing step A, a prearranging step B, a securing step C, and a lodging step D. In the preparing step A, the fastener 5 includes a holder 51, a screw 6 penetrating the holder 51, and a cover 52 enveloping the holder 51. The holder 51 has a body 511 formed with an accommodating room 512 therein, and a tube 513 extended outward from the body 511. A through hole 514 defined in the tube 513 is communicated with the accommodating room 512. In this embodiment, a top periphery of the body 511 is radially surrounded with a fixing part 515. A combining part 521 corresponding to the fixing part 515 is disposed on the cover 52. Thereby, interlocking the combining part 521 with the fixing part 515 contributes to a compact structure.

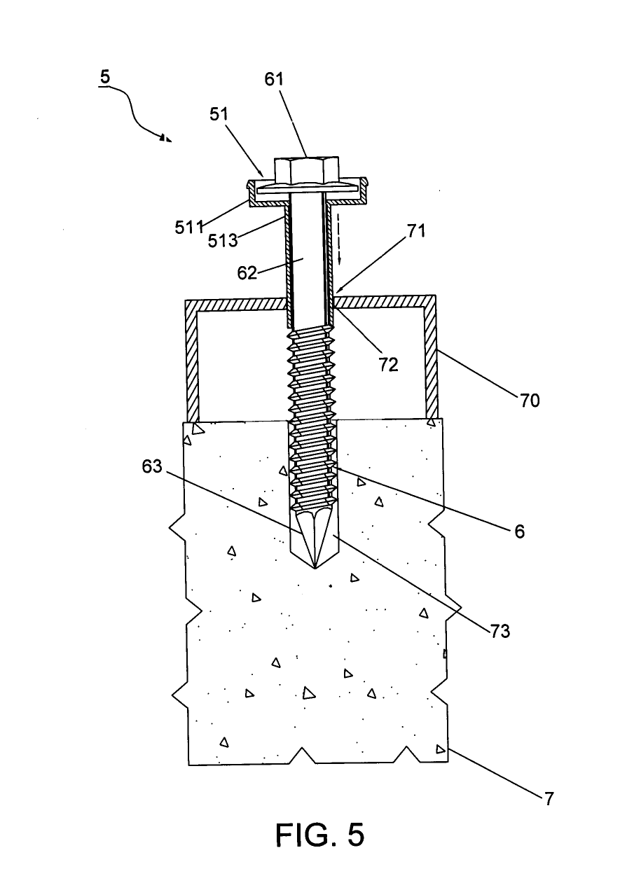

Continuingly referring to FIG. 5, the fastener 5 is applied to combine a metal object 70 with a target object 7. In the prearranging step B, the screw 6 passes through the accommodating room 512 and the through hole 514 for penetrating the holder 51 and combining with the same. At the same time, a pre-drilled hole 71 is pre-drilled on the metal object 70, and a receiving area 72 is formed on the pre-drilled hole 71 for receiving the tube 513. Favorably, a drilling area 73 is further defined on the target object 7 for the screw 6 to drill. In the securing step C, the screw 6 sleeved with the holder 51 is screwed into the pre-drilled hole 71 of the metal object 70, the screw 6 is continuously secured into the drilling area 73 of the target object 7, and in time of securing, the tube 513 is pushed by the screw 6 toward the receiving area 72. Thereby, the head 61 and a shank 62 of the screw 6 are preferably separated from the metal object 70 via the holder 51. Finally in the lodging step D, the cover 52 is placed on the holder 51. Thereby, the head 61 of the screw 6 is sheltered via the cover 52.

Referring to FIGS. 3 and 5, in operation, the holder 51, the cover 52 and the screw 6 are previously prepared in the preparing step A. Herein, the screw 6 travels through the holder 51, the pre-drilled hole 71 is previously formed on the metal object 70, the receiving area 72 is defined on the pre-drilled hole 71, and the drilling area 73 is advancely defined on the target object 7. Thereby, the screw 6 sleeved with the holder 51 proceeds to the securing operation. Namely, the screw 6 with the holder 51 enters the pre-drilled hole 71 of the metal object 70 until a drilling point 63 of the screw 6 contacts the surface of the drilling area 73. Imparting a screwing torque upon the head 61 of the screw 6 further secures the screw 6 into the drilling area 73 of the target object 7. In the meantime, the holder 51 is pushed by the screw 6 to penetrate the tube 513 through the receiving area 72, and the head 61 of the screw 6 is fitly placed in the body 511, which means the head 61 and the shank 62 of the screw 6 are capable of being separated from the metal object 70 via the dispositions of the holder 51 and the tube 513. Thereby, the securing step C is completed.

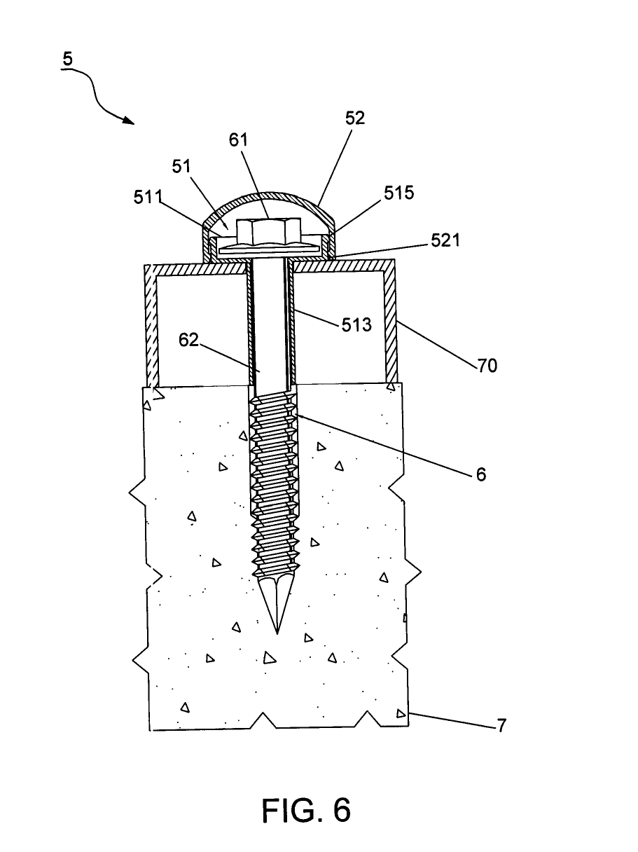

Referring to FIGS. 3 and 6, while the screw 6 and the holder 51 are secured, the cover 52 is thence placed to engage with the body 511 of the holder 51. Herein, the combining part 521 imparts a force on the correspondent fixing part 515 for conducing to a compact engagement. Preferably, in the lodging step D, the head 61 and partial shank 62 of the screw 6 are respectively separated from the exterior and the metal object 70 via the cover 52 and the holder 51. Thus, liquid or mist in the atmosphere is unable to get in the head 61 through the convergence of the cover 52 and the holder 51, so as to avoid damaging the head 61. Additionally, since the secured fastener 5 offers a separation between the metal object 70 and the screw 6 via the holder 51, the screw 6 does not directly contact the metal object 70 to generate the potential difference. Thus, the screw 6 is not readily oxidized or rusty by the potential difference, which benefits that the fastener 5 still retains a stable fixing feature even after a long period of using time.

Accordingly, advantages and features of the present invention are as follows:

1. The combining part 521 and the fixing part 515 contribute to a compact engagement between the cover 52 and the holder 51. By means of the compact engagement, the holder 52 does not readily fall off in view of any accidental exterior force. Preferably, the sheltered head 61 of the screw 6 does not easily chafe the skin on people, and the liquid in the atmosphere could not facilely get in the fastener 5 through the convergence of the cover 52 and the holder 51, so as to avoid damaging the head 61. Thereby, the integral securing effect and using safety of the screw 6 could be ensured.

2. By means of the tube 513 being protruded outward from the body 511, the head 61 and the shank 62 of the screw 6 are preferably separated from the metal object 70 while being secured to the target object 7. Thus, the elements do not directly contact each other, so no potential difference would be generated between two metals of different features. Thereby, the screw 6 is not subject to rustiness for the fastener 5 to retain a long-lasting fixing trait even after a long period of using time.

To sum up, the present invention particularly prevents the screw from the direct contact with the metal object via the holder to avoid any oxidization occurred on the screw. Thus, the screw retains a long-lasting fixing feature even after a long period of using time.

While we have shown and described the embodiment in accordance with the present invention, it should be clear to those skilled in the art that further embodiments may be made without departing from the scope of the present invention.

I claim:

1. A fastening method of a fastener, applied to combine a metal object with a target object, comprising steps of:
a preparing step: a fastener being prepared; said fastener having a holder, a screw penetrating said holder, and a cover enveloping said holder; said holder having a body with an accommodating room formed therein, and a tube extended outward from said body; a through hole defined in the tube being communicated with said accommodating room;
a prearranging step: said screw penetrating its correspondent holder by sequentially traveling through said accommodating room and said through hole to engage with said holder; a pre-drilled hole being pre-drilled on said metal object; a receiving area being formed along said pre-drilled hole for accommodating said tube;
a securing step: said screw sleeved with said holder being brought into said pre-drilled hole of said metal object and thence fixed to said target object; fixing said screw allowing said tube to be pushed by said screw for propping against said receiving area, thereby separating a shank of said screw from said metal object via said holder; and
a lodging step: said cover being placed on said body of said holder for sheltering a head of said screw.

2. The method and structure as claimed in claim 1, wherein, a top periphery of said body is radially surrounded with a fixing part, and a combining part corresponding to said fixing part is disposed on said cover, so that said combining part is capable of compactly interlocking with said fixing part.
